(19) United States
(12) Patent Application Publication
(10) Pub. No.: US 2016/0024374 A1
(43) Pub. Date: Jan. 28, 2016

(54) FERROFLUIDS ABSORBED ON GRAPHENE/GRAPHENE OXIDE FOR EOR

(71) Applicant: Baker Hughes Incorporated, Houston, TX (US)

(72) Inventors: ANIL K. SADANA, Houston, TX (US); Gaurav Agrawal, Aurora, CO (US); Oleg A. Mazyar, Houston, TX (US)

(73) Assignee: Baker Hughes Incorporated, Houston, TX (US)

(21) Appl. No.: 14/338,894

(22) Filed: Jul. 23, 2014

(51) Int. Cl. C09K 8/592; E21B 43/16; E21B 43/24; C09K 5/10; H01F 1/44

(52) U.S. Cl. CPC C09K 8/592; C09K 5/10; H01F 1/44; H01F 1/442; H01F 1/445; E21B 43/24; E21B 43/164

(57) ABSTRACT

Magnetic materials, such as ferrofluids, are known to produce large amounts of heat per unit volume. Other magnetic materials include iron, iron oxide, iron carbide, iron nitride, cobalt-nickel alloy, iron-platinum alloy, cobalt-platinum alloy, iron-molybdenum alloy, iron-palladium alloy, cobalt ferrite, and combinations thereof. These magnetic materials may be absorbed onto a graphene-like component or may be encapsulated by a graphene-like component to give thermal particles. These thermal particles may in turn be suspended in a carrier fluid such as water and/or brine to give a heat transfer fluid that may be used for the dissipation of heat in downhole and subterranean environments, particularly for enhanced oil recovery (EOR) processes, including, but not necessarily limited to, carbon dioxide (CO₂) flooding and alternatives to steam-assisted gravity drainage (SAGD). The magnetic materials may be excited by induction heating.

### TECHNICAL FIELD

The present invention relates to compositions and methods for alternative forms of enhanced oil recovery (EOR), and more particularly relates, in one non-limiting embodiment, to compositions and methods for alternative forms of EOR that involve heat transfer fluids having thermal particles therein to aid the transfer of heat.

### TECHNICAL BACKGROUND

There are a number of enhanced oil recovery (EOR) techniques that involve the transfer of heat, including but not necessarily limited to, the heating of a medium which is then moved to a subterranean location to heat another material or region via heat transfer or heat dissipation.

One such EOR technique is Steam Assisted Gravity Drainage (SAGD) for producing heavy crude oil and bitumen. It is an advanced form of steam stimulation in which at least two horizontal wells are drilled into a subterranean oil reservoir, one a few feet or meters above the other. High pressure steam is continuously injected into the upper wellbore to heat the oil or bitumen and reduce its viscosity, causing the heated oil to drain into the lower wellbore, where it is pumped out. SAGD was developed to recover deposits of bitumen that were too deep for mining. SAGD is presently used to produce oil sands, most notably those in Alberta, Canada, and also heavy crude oil.

Canada is the single largest supplier of imported oil to the United States. There are two primary methods of oil sands recovery. The strip-mining technique is known best. SAGD and Cyclic Steam Stimulation (CSS) are two commercially applied primal thermal recovery processes used in the oil sands. However, the more recent SAGD is better suited to deeper deposits. It is expected that much of the future growth of production in the Canadian oil sands will be from SAGD.

Another EOR process that requires the transfer of heat is carbon dioxide (CO₂) flooding. CO₂ flooding is a process whereby carbon dioxide is injected into an oil reservoir in order to increase output when extracting oil. When a reservoir's pressure is depleted through primary and secondary production, CO₂ flooding may be a suitable tertiary recovery method. It is particularly effective in reservoirs deeper than about 2,500 ft. (about 762 m), where CO₂ will be in a supercritical state, with an API oil gravity greater than 22-25° and remaining oil saturations greater than 20%. It should also be noted that CO₂ flooding is not affected by the lithology of the reservoir area but simply by the reservoir characteristics. CO₂ flooding works on the physical phenomenon that by injecting CO₂ into the reservoir, the viscosity of any hydrocarbon will be reduced and hence will be easier to sweep to a production well.

If a well has been produced before and is suitable for CO₂ flooding, first the pressure within the reservoir is restored to one suitable for production. This is done by injecting water (with the production well shut off) which will restore pressure within the reservoir to a suitable pressure for CO₂ flooding. Once the reservoir is at this pressure, the CO₂ is next injected into the same injection wells used to restore pressure. The CO₂ gas is forced into the reservoir and is required to come into contact with the oil. This creates a miscible zone that can be moved more easily to the production well. Normally the CO₂ injection is alternated with more water injection and the water acts to sweep the oil towards the production zone.

Accordingly, it is desired to provide compositions and methods which provide alternative methods for transferring heat to and within locations in subterranean formations.

### SUMMARY

There is provided in one non-limiting embodiment a method for introducing heat into a subterranean location, where the method includes, not necessarily in this order, heating thermal particles in a heat transfer fluid, where the heat transfer fluid includes a carrier fluid selected from the group consisting of water, brine, light hydrocarbons (i.e.. methane, ethane, propane and butane), light crude oil, naphtha, diesel fuel, organic solvents, ammonia, carbon dioxide, natural gas, nitrogen, and combinations thereof, and a plurality of thermal particles having at least two components: (1) a graphene-like component selected from the group consisting of graphene, functionalized graphene, graphene oxide, graphite, carbon nanotubes, fullerenes, carbon onions, boron nitride, and mixtures thereof, and (2) a magnetic material. The method further involves introducing the heat transfer fluid into a subterranean location. The method further involves transferring heat from the heat transfer fluid to the subterranean location. In one non-limiting example, the magnetic material and/or the graphene-like component is heated by induction heating and the heat transfer fluid is pumped to a different location.

There is additionally provided in one non-restrictive version, a heat transfer fluid that includes a carrier fluid selected from the group consisting of water, brine and combinations thereof and a plurality of thermal particles selected from the group consisting of graphene, functionalized graphene, graphene oxide, carbon nanotubes, fullerenes, carbon onions, boron nitride, and mixtures thereof, and a magnetic material.

### DETAILED DESCRIPTION

A method has been discovered for combining magnetic materials with a graphene-like component to give thermal particles which are suspended in a carrier fluid to fluid to form a heat transfer fluid, whereby the thermal particles are heated, such as by induction heating, and the carrier fluid is transported to a subterranean formation location for dissipation of the heat in a useful manner. Non-limiting examples of useful dissipation of the heat include, but are not necessarily limited to, heating oil and/or bitumen to a temperature sufficient for the oil or bitumen to flow by gravity (such as in a SAGD-type process) or heating carbon dioxide to a supercritical state and flooding a reservoir with the supercritical carbon dioxide.

In more detail, the carrier fluid may include, but is not necessarily limited to, water, brine, light hydrocarbons (i.e. methane, ethane, propane, butane, pentane, and combinations thereof), light crude oil, naphtha, diesel fuel, organic solvents, ammonia, carbon dioxide, natural gas, nitrogen, and/or combinations thereof (e.g. mixtures). Organic solvents include, but are not necessarily limited to, xylene, toluene, hexane, benzene, Aromatic 100, terpenes, glycol ethers, alkyl ethers of ethylene glycol, alkyl ethers of propylene glycol, ethylene glycol, EGMBE (ethylene glycol mono-butyl ether), propylene glycol n-butyl ether, diethylene glycol butyl ether, ethylene glycol monoacetate, butyl carbitol, triethylene glycol monoethyl ether, 1,1′-oxybis(2-propanol), triethylene glycol monomethyl ether, triglyme, diglyme, dialkyl methyl glutarate, dialkyl adipate, dialkyl ethylsuccinate, dialkyl succinate, dialkyl glutarate, and combinations thereof. The non-aqueous fluids are noted herein as potentially useful for carrier fluids because the method described here may also be combined with steam and gas push (SAGP) recovery methods where a small amount of non-condensable gas is added to reduce the amount of steam to be injected. The compositions and methods herein may also be used with an expanded solvent SAGD process having the aim of combining the benefits of steam and solvent in the recovery of heavy oil and bitumen. In this process, the solvent is injected together with steam in a vapor phase. It condenses around the interface of the steam chamber and dilutes the oil. Solvent in conjunction with heat reduces oil viscosity. The methods and compositions described herein may even be used with processes that are typically non-thermal like VAPEX (vapor extraction), similar to SAGD, where the steam chamber is replaced with the chamber containing light hydrocarbon vapor close to its dew point at the reservoir pressure. The mechanism for the oil viscosity reduction is dilution by molecular diffusion of the solvent in the oil. Diluted oil or bitumen driven by gravity drains to the production horizontal well located below the horizontal injection well. Additionally, the compositions and methods herein may also be used in a cyclic solvent injection process for in situ precipitation of asphaltenes. The principle of this technology is to separate a valuable crude oil and an asphaltene fraction by liquid-liquid extraction with a light paraffinic hydrocarbon solvent. Generally, the solvent used is a mixture of propane cut and butane cut. A combination of a VAPEX process or a cyclic solvent injection process with heating the reservoir using the method described here is expected to improve EOR.

The graphene-like components may include, but are not necessarily limited to, graphene, functionalized graphene, graphite, carbon nanotubes, fullerenes, carbon onions, boron nitride, and mixtures thereof. By “graphene-like” is meant a material that is highly thermally conductive and has a generally planar structure that is monoatomic (one atom thick) layers or multiple monoatomic layers. While it is not necessarily a requirement, the atoms in these graphene-like components have a generally hexagonal configuration or pattern, although these sheets may also contain pentagonal (or sometimes heptagonal) rings.

While it is expected that a very suitable form of functionalized graphene will be graphene oxide, graphene containing other function groups is also expected to be useful. These other functional groups include, but are not necessarily limited to, carboxylic acid, hydroxyl, epoxide, amine, amide, and combinations thereof; and combinations of these. In the embodiments where the carrier fluids are non-aqueous, such as light hydrocarbons, the suitable functional groups may include, but are not necessarily limited to, alkyl groups, aryl groups and combinations of these.

Graphene is the single-layer form of graphite. Graphene oxide (GO) is a compound of carbon, hydrogen and oxygen in various ratios, obtained by treating graphite with strong oxidizers, and may be roughly envisioned as a sheet with the carbon atoms arranged in a hexagonal, planar pattern having hydroxyl groups (—OH) and carboxyl groups (—COOH) at some sites along the edges of the sheet, and hydroxyl groups and epoxy groups (—O—) at some sites of the sheet interior. Suitable graphene shapes include, but are not necessarily limited to, monolayers, multilayers, twisted layers and curved layers. Generally, all graphene is considered to be highly thermally conductive.

The average thickness of the graphene-like particles may range between about 0.3 independently to about 100 nanometers; alternatively between about 1 independently to about 20 nanometers. The average largest dimension of the graphene-like particles may range between about 5 independently to about 50 microns; alternatively between about 10 independently to about 25 microns. The word “independently” as used herein with respect to a range means that any lower threshold may be used together with any upper threshold to give a suitable alternative range.

Graphite is almost entirely made of carbon atoms, and while not always existing in planar forms, may exist in the planar form of graphene as previously mentioned. Graphite may be understood as stacked graphene sheets. Graphite in finely-divided particulate form may also be suitable herein, for instance as a suitable substrate into or upon which the magnetic material such as ferrofluids may be absorbed or otherwise combined therewith.

Carbon nanotubes (CNTs) are allotropes of carbon with a cylindrical nanostructure, and have been constructed with a length to diameter ratio of 132,000,000:1. Like the other graphene-like components they have extraordinary thermal conductivity. CNTs may be double-, triple- and multiwalled. They may be “unzipped” to give sheets or layers. The magnetic materials may be encapsulated by the CNTs and other graphene-like components as a core within a graphene-like component, which structures will be described in more detail below.

Fullerenes are molecules formed entirely of carbon in the form of a hollow sphere, ellipsoid, tube and other shapes. Spherical fullerenes are also called buckyballs, and they resemble the geodesic domes designed by Buckminster Fuller, as well as the balls used in football (soccer). Fullerenes, and “nesting” multiple fullerenes within each other, may serve to encapsulate and form shells around the magnetic materials. Carbon onions or “bucky onions” consist of spherical, or generally spherical, closed carbon shells and owe their name to the concentric layered structure resembling that of an onion. Carbon onions are sometimes also called carbon nano-onions (CNOs) or onion-like carbon (OLC). These names cover all types of concentric shells, from nested fullerenes to small (less than 100 nm) polyhedral nanostructures.

Boron nitride (BN) is not a carbon-containing molecule, but is graphene-like in that it can exist in a planar, hexagonal form that corresponds to graphite and is also highly thermally conductive; this form of boron nitride is the most stable and softest among BN polymorphs. Boron nitride has the chemical formula BN and consists of equal numbers of boron and nitrogen atoms, is isoelectronic to the similarly structure carbon lattice of graphene, and exists in various crystalline forms.

Suitable magnetic materials for use in combination with the graphene-like components include, but are not necessarily limited to, ferrofluids, iron, iron oxide, iron carbide, iron nitride, cobalt-nickel alloy, iron-platinum alloy, cobalt-platinum alloy, iron-molybdenum alloy, iron-palladium alloy, cobalt ferrite, a cobalt core with a platinum shell, a platinum core with a cobalt shell, and combinations thereof. These materials are superparamagnetic and/or ferromagnetic and/or ferrimagnetic and may be easily heated by induction heating or other heating techniques.

The ferrofluids used herein are liquids which become strongly magnetized in the presence of a magnetic field. They are colloidal liquids made of nanoscale superparamagnetic, ferromagnetic and/or ferrimagnetic particles suspended in a carrier fluid, typically an organic solvent or water. Each nanoparticle is coated with a surfactant to inhibit the nanoparticles from clumping or agglomerating together. The nanoparticles may also be covalently functionalized to provide good quality of colloidal suspension. In one non-limiting embodiment, the ferrofluid comprises nanoparticles selected from the group consisting of iron (II) oxide (Fe₂O₃), iron (II, III) oxide (Fe₃O₄) and combinations thereof, and the nanoparticles have an average particle size between about 5 nm independently to about 100 nm; alternatively between about 10 independently to about 20 nm.

Generally, the ferrofluids, or other magnetic materials, are adsorbed onto the graphene particles simply by contacting the two materials, where the ferrofluids are attracted by the functional groups on the graphene particles. Alternatively, it may be that the magnetic nanoparticles, rather than the ferrofluids, are attracted by graphene, in a non-limiting explanation. Additionally, the magnetic nanoparticles may be covalently linked or bonded to the graphene particles by molecular chains. Such a structure would be a different embodiment from the core-shell particle structure. The loading of the magnetic material, e.g. ferrofluid, absorbed on the graphene particles ranges from about 1 independently to about 25 weight %; alternatively from about 5 independently to about 10 weight %.

In another non-limiting embodiment, the magnetic material may be incorporated inside the shell of the graphene-like component which effectively disperses heat generated within the magnetic material. The benefits of having a shell include, but are not necessarily limited to, that the shell prevents or inhibits the corrosion of the metal or metal oxide core in the subterranean reservoir environment, where corrosive materials include, but are not necessarily limited to carbon dioxide (CO₂), hydrogen sulfide (H₂S), acids, corrosive brines). Further, the shell may be functionalized (have functional groups attached thereto) to improve the quality of the colloidal suspension (good dispersion; including being stable over time and elevated temperatures) and to prevent adhesion of the thermal particles to the rock surface. Also, as noted, it is expected that many other nanomaterial's which are super paramagnetic or ferromagnetic may be usefully employed in addition to iron oxides.

More specifically, the thermal particles may be core-shell nanoparticle. A nanoparticle is defined as any particle where the average particle size is at or below 999 nm. Magnetic (superparamagnetic, ferromagnetic) nanoparticles may be mechanically entrapped in a graphene-like carbon shell or a boron nitride shell. Such coatings on magnetic nanoparticles may consist of a few highly thermally conductive graphene sheets that envelope the magnetic core. These coatings disperse a heat generated within the magnetic core and provide an anticorrosion barrier for the magnetic core nanoparticles which are often vulnerable to the corrosive effects of brines, carbon dioxide, hydrogen sulfide and acids present in the oil-bearing reservoirs. Graphene-like carbon coatings on magnetic cores may be covalently functionalized with functional groups or surface-treated with surface-active compounds to customize or fine-tune the particles' surface properties to improve the quality of colloidal suspensions and to prevent the particles' adhesion to the reservoir rock surfaces. The graphene-like carbon shell can also be covalently linked to other nanoparticles having high thermal conductivity (graphene, graphene oxide, graphite, carbon nanotubes, fullerenes, carbon onion-like structures, boron nitride platelets and the like) to form a tighter bond.

The magnetic core may be made of iron, iron oxide, iron carbide, iron nitride (see C.-J. Choi, et al., “Preparation and Characterization of Magnetic Fe, Fe/C and Fe/N Nanoparticles Synthesized by Chemical Vapor Condensation Process”, Reviews on Advanced Materials Science, v. 5, p. 487 (2003)), CoNi alloys, FePt alloys (see M. Vazquez, et al., “Magnetic Nanoparticles: Synthesis, Ordering and Properties”, Physica B, v. 354, p. 71 (2004)), CoPt alloys (see V. Tzitzios, et al., “Synthesis of CoPt Nanoparticles by a Modified Polyol Method: Characterization and Magnetic Properties”, Nanotechnology, v. 16, p. 287 (2005)), FeMo alloys (see Y. Li, et al., “Preparation of Monodispersed Fe—Mo Nanoparticles as the Catalyst for CVD Synthesis of Carbon Nanotubes”, Chemistry of Materials, v. 13, p. 1008 (2001)), FePd alloys (see Y. Hou; et al., “Preparation and Characterization of Monodisperse FePd Nanoparticles”, Chemistry of Materials, v. 16, p. 5149 (2004)), cobalt ferrite (T. Hyeon, et al., “Synthesis of Highly Crystalline and Monodisperse Cobalt Ferrite Nanocrystals”, Journal of Physical Chemistry B, v. 106, p. 6831 (2002)) and the like.

The magnetic core itself may be represented as core-shell nanoparticles. Core-shell magnetic nanoparticles in which platinum resides as a shell around a cobalt core are described in J.-I.; Park, et al., “Synthesis of “Solid Solution” and “Core-Shell” Type Cobalt-Platinum Magnetic Nanoparticles via Transmetalation Reactions”, Journal of the American Chemical Society, v. 123, p. 5743 (2001). Magnetic nanoparticles where a noble metal core of platinum is surrounded by a magnetic Co shell are described in N. S. Sobal, et al., “Synthesis of Core-Shell PtCo Nanocrystals”, Journal of Physical Chemistry B, v. 107, p. 7351 (2003).

Encapsulating carbonaceous coating around the magnetic core nanoparticles may be made by hydrothermal treatment of glucose at 160-180° C. Without wishing to be bound by any one theory, it is believed that the carbonization occurs as a result of crosslinking induced by intermolecular dehydration of oligosaccharides or other macromolecules formed under the hydrothermal conditions. Followed by calcination at 900° C., this process produces graphene-like-coated magnetic core-shell nanoparticles (see N. Caiulo, et al., “Carbon-Decorated FePt Nanoparticles”, Advanced Functional Materials, v. 17, p. 1392 (2007)). It should be appreciated that all of the above-identified articles are incorporated herein by reference in their entirety.

Manufacture of the thermal particles described herein may be accomplished by other methods known in the art, including, but not necessarily limited to, microencapsulation, chemical vapor deposition (CVD), plasma assisted CVD, or pyrolysis of organometallics in particular metallocenes, and the like.

The amount or loading of the graphene particles in the heat transfer fluid may ranges from about 0.5 independently to about 5 wt %, the balance being carrier fluid (e.g. water and/or brine). Alternative, the loading of the graphene particles in the heat transfer fluid may range from about 2 independently to about 5 wt %.

The thermal particles have an average particle size between about 10 nm independently to about 100 nm; alternatively between about 1 nm independently to about 100 microns.

Graphene oxide may be suspended in the carrier fluid without the need for a surfactant. The GO itself may act as a surfactant as described in the article L. J. Cote, et al., “Graphene Oxide as Surfactant Sheets,” Pure Appl. Chem., Vol. 83, No. 1, pp. 95-110, 2011, incorporated herein by reference in its entirety.

Alternatively, surfactants may be used to help keep the thermal particles suspended in the heat transfer fluid. Suitable surfactants may be those known to suspend the ferromagnetic and/or ferrimagnetic nanoparticles in its own carrier fluid, as known in the art. The amounts may be any amount effective to keep the graphene particles suspended so that they do not settle out over time. Optionally, the surfactants may be those that have multiple or additional hydrophilic groups so that the extra functional group cleaves and renders the surfactant more soluble in oil. Other suitable surfactants include, but are not necessarily limited to, cationic surfactants, anionic surfactants, non-ionic surfactants, amphiphilic surfactants, and combinations thereof. Suitable difunctional surfactants of this type include, but are not necessarily limited to, the cleavable di-functional anionic surfactants described in U.S. Patent Application Publication No. 2011/0048721 A1 and the styryl phenol alkoxylated sulfate surfactants described in U.S. Patent Application Publication 2011/0190174 A1, both of which are incorporated herein by reference in their entirety.

These patent applications also disclose ways of using the heat transfer fluids described herein. For instance, the heat transfer fluids may be used by injecting the fluids into hydrocarbon-bearing formations, and once in the hydrocarbon-bearing formation, the surfactant cleaves and releases a more oil-soluble surfactant to more closely contact the oil or bitumen and transfer heat to it. In another non-limiting embodiment, the heat transfer fluids herein having an increased temperature are injected into a hydrocarbon bearing formation to contact and push or sweep oil to a production well in an Enhanced Oil Recovery (EOR) treatment, or clean out oil from a formation and/or aquifer remediation work.

In one non-limiting embodiment, it is expected that the heat transfer fluids may be heated to a temperature in the range of about 40 independently to about 100° C.; alternatively in the range of about 60 independently to about 350° C.

The heat transfer fluids described herein may be heated by any known method. One acceptable method is inductive heating of the ferromagnetic nanoparticles using an alternating current magnetic field, as described in C. H. Li, et al., “Experimental Study of Fundamental Mechanisms in Inductive Heating of Ferromagnetic Nanoparticles Suspension (Fe3O4 Iron Oxide Ferrofluid),” Journal of Applied Physics, Vol. 110, 054303, 2011, incorporated herein by reference in its entirety. This investigation found that the primary heating mechanism for 50 nm magnetite nanoparticles was due to the hysteresis loss mechanism. The Brownian relaxation mechanism was found responsible for up to 25% of the heating in the aqueous carrier at high field intensity and low frequency. The relative importance of the Brownian relaxation mechanics will be less with the increase of applied field frequency when the frequency is in the range one order of magnitude higher than the residual frequency of the nanoparticles in tests. At both low magnetic field intensity with low frequency, and at high frequency with low intensity, it had virtually no effect on heating. In addition, when the nanoparticles were suspended in the aqueous carrier, the specific absorption rate (SAR) tended to deviate from both the expected linear relationship against frequency, as well as the expected quadratic trend against the magnetic field intensity. Finally, the experimental SAR results were found to be in accordance with the theoretical approximation.

In another non-restrictive embodiment, the heat transfer fluid is placed in a designated location and then remotely (or not) inductively heated. The benefits are that there are no heat losses during the transportation of the fluid to the designated location and the designated location is uniformly heated because the heat-emitting particles are uniformly distributed within the location.

In summary, the methods and compositions described herein combine the energy absorbing ferromagnetic material (iron/iron oxide core) and energy dispersant (graphene) as one entity so that the material may absorb heat from a heat source or be inductively heated and then distribute heat/energy more efficiently in a reservoir.

In the foregoing specification, the invention has been described with reference to specific embodiments thereof, and has been demonstrated as effective in providing methods and compositions for improving and increasing the transfer of heat within and to a subterranean formation. However, it will be evident that various modifications and changes can be made thereto without departing from the broader spirit or scope of the invention as set forth in the appended claims. Accordingly, the specification is to be regarded in an illustrative rather than a restrictive sense. For example, specific combinations of carrier fluids, magnetic materials, ferrofluids, graphene-like components, graphene particles, functional groups, shell materials, surfactants, and other components falling within the claimed parameters, but not specifically identified or tried in a particular composition or method, are expected to be within the scope of this invention. Additionally, it is expected that the methods of heating the heat transfer fluid and methods of dissipating heat from the heat transfer fluids may change somewhat from one application to another and still accomplish the stated purposes and goals of the methods described herein. Further, the methods herein may use inductive heating methods, different temperatures, pressures, pump rates and additional or different steps than those mentioned or exemplified herein.

The words “comprising” and “comprises” as used throughout the claims is to be interpreted “including but not limited to” and “includes but not limited to”, respectively.

The present invention may suitably comprise, consist of or consist essentially of the elements disclosed and may be practiced in the absence of an element not disclosed. For instance, there may be provided a method for introducing heat into a subterranean location, which method consists essentially of or consists of, and not necessarily in this order, introducing into a subterranean location a heat transfer fluid, where the heat transfer fluid comprises, consists essentially of or consists of a carrier fluid selected from the group consisting of water, brine, light hydrocarbons, light crude oil, naphtha, diesel fuel, organic solvents, ammonia, carbon dioxide, natural gas, nitrogen, and combinations thereof and a plurality of thermal particles comprising a graphene-like component selected from the group consisting of graphene, functionalized graphene, graphite, carbon nanotubes, fullerenes, carbon onions, boron nitride, and mixtures thereof, and a magnetic material, and the method further consists essentially of or consists of transferring heat from the heat transfer fluid to the subterranean location. Heating of the ferrofluid and the graphene particles may be done prior to introducing the heat transfer fluid into a subterranean location, such as by inductive heating.

Alternatively, there may be provided a heat transfer fluid that consists essentially of or consists of a carrier fluid selected from the group consisting of water, brine, light hydrocarbons, light crude oil, naphtha, diesel fuel, organic solvents, ammonia, carbon dioxide, natural gas, nitrogen, and combinations thereof, and a plurality of thermal particles comprising, consisting essentially of or consisting of a graphene-like component selected from the group consisting of graphene, functionalized graphene, carbon nanotubes, fullerenes, carbon onions, boron nitride, and mixtures thereof, and the thermal particles also comprise, consist essentially of or consist of a magnetic material, and optionally a surfactant.

What is claimed is:

1. A method for introducing heat into a subterranean location, the method comprising, not necessarily in this order:
heating thermal particles in a heat transfer fluid, where the heat transfer fluid comprises:
a carrier fluid selected from the group consisting of water, brine, light hydrocarbons, light crude oil, naphtha, diesel fuel, organic solvents, ammonia, carbon dioxide, natural gas, nitrogen, and combinations thereof; and
a plurality of thermal particles comprising:
a graphene-like component selected from the group consisting of graphene, functionalized graphene, graphite, carbon nanotubes, fullerenes, carbon onions, boron nitride, and mixtures thereof, and
a magnetic material;
introducing the heat transfer fluid into a subterranean location; and
transferring heat from the heat transfer fluid to the subterranean location.

2. The method of claim 1 where the graphene-like component is selected from the group consisting of a graphene-like particle substrate having the magnetic material absorbed thereon, a graphene-like shell at least partially surrounding the magnetic material, the magnetic material covalently bonded to the graphene-like component, and combinations thereof.

3. The method of claim 2 where the graphene-like particles have an average thickness between about 5 to about 10 nanometers and have an average largest dimension between about 5 to about 50 microns.

4. The method of claim 1 where the magnetic material is selected from the group consisting of a ferrofluid, iron, iron oxide, iron carbide, iron nitride, cobalt-nickel alloy, iron-platinum alloy, cobalt-platinum alloy, iron-molybdenum alloy, iron-palladium alloy, cobalt ferrite, a cobalt core with a platinum shell, a platinum core with a cobalt shell, and combinations thereof.

5. The method of claim 4 where the ferrofluid comprises nanoparticles selected from the group consisting of Fe₂O₃, Fe₃O₄ and combinations thereof, and the nanoparticles have an average particle size between about 5 nm to about 100 nm.

6. The method of claim 1 further comprising transferring heat from the heat transfer fluid to the subterranean reservoir.

7. The method of claim 1 where the method further comprises at least one further enhanced oil recovery step selected from the group consisting of:
heating oil and/or bitumen to a temperature sufficient for the oil and/or bitumen to flow by gravity;
heating carbon dioxide to a supercritical state and flooding a reservoir with the supercritical carbon dioxide;
sweeping a hydrocarbon to a production well;
cleaning oil from a subterranean formation; and
combinations thereof.

8. The method of claim 7 where heating the transfer fluid comprises heating the thermal particles by induction heating.

9. The method of claim 1 where the functionalized graphene is selected from the group consisting of graphene oxide; graphene comprising functional groups selected from the group consisting of carboxylic acid, hydroxyl, epoxide, amine, amide, and combinations thereof; and combinations of these.

10. The method of claim 1 where the loading of the magnetic material on the thermal particles ranges from about 1 to about 15 weight %.

11. The method of claim 1 where the amount of the plurality of thermal particles in the heat transfer fluid ranges from about 0.5 to about 5 wt %.

12. The method of claim 1 where the heat transfer fluid additionally comprises a surfactant in an amount effective to suspend the graphene particles in the carrier fluid.

13. The method of claim 12 where the surfactant is selected from the group consisting of cleavable di-functional anionic surfactants, styryl phenol alkoxylated sulfate surfactants, and combinations thereof.

14. A method for introducing heat into a subterranean location, the method comprising, not necessarily in this order:
heating thermal particles in a heat transfer fluid, where the heat transfer fluid comprises:
a carrier fluid selected from the group consisting of water, brine, light hydrocarbons, light crude oil, naphtha, diesel fuel, organic solvents, ammonia, carbon dioxide, natural gas, nitrogen, and combinations thereof;
a plurality of thermal particles having an average particle size between about 1 to about 100 microns, where the thermal particles comprise:
a graphene-like component selected from the group consisting of graphene, functionalized graphene, graphite, carbon nanotubes, fullerenes, carbon onions, boron nitride and mixtures thereof, and
a magnetic material selected from the group consisting of a ferrofluid, iron, iron oxide, iron carbide, iron nitride, cobalt-nickel alloy, iron-platinum alloy, cobalt-platinum alloy, iron-molybdenum alloy, iron-palladium alloy, cobalt ferrite, a cobalt core with a platinum shell, a platinum core with a cobalt shell, and combinations thereof, where the loading of the magnetic material absorbed on the thermal particles ranges from about 1 to about 15 weight %;
introducing the heat transfer fluid into a subterranean location; and
transferring heat from the heat transfer fluid to the subterranean location.

15. A heat transfer fluid comprising:
a carrier fluid selected from the group consisting of water, brine, light hydrocarbons, light crude oil, naphtha, diesel fuel, organic solvents, ammonia, carbon dioxide, natural gas, nitrogen, and combinations thereof; and
a plurality of thermal particles comprising:
a graphene-like component selected from the group consisting of graphene, functionalized graphene, carbon nanotubes, fullerenes, carbon onions, boron nitride, and mixtures thereof, and
a magnetic material.

16. The heat transfer fluid of claim 15 where the thermal particles have an average particle size between about 1 nm to about 100 microns.

17. The heat transfer fluid of claim 15 where the magnetic material is selected from the group consisting of a ferrofluid, iron, iron oxide, iron carbide, iron nitride, cobalt-nickel alloy, iron-platinum alloy, cobalt-platinum alloy, iron-molybdenum alloy, iron-palladium alloy, cobalt ferrite, a cobalt core with a platinum shell, a platinum core with a cobalt shell, and combinations thereof.

18. The heat transfer fluid of claim 15 where the loading of the magnetic material on the thermal particles ranges from about 1 to about 15 weight %.

19. The heat transfer fluid of claim 15 where the amount of the plurality of thermal particles in the heat transfer fluid ranges from about 0.5 to about 5 wt %.

20. The heat transfer fluid of claim 15 where the heat transfer fluid additionally comprises a surfactant in an amount effective to suspend the graphene particles in the carrier fluid.
